(19) United States
(12) Patent Application Publication
(10) Pub. No.: US 2025/0392003 A1
(43) Pub. Date: Dec. 25, 2025

(54) PERMSELECTIVE INTERLAYER

(71) Applicant: MONASH UNIVERSITY, Clayton, Victoria (AU)

(72) Inventors: Petar Jovanovic, Clayton (AU); Mahdokht Shaibani, Clayton (AU); Mainak Majumder, Clayton (AU)

(21) Appl. No.: 18/878,227

(22) PCT Filed: Jun. 27, 2023
(86) PCT No.: PCT/AU2023/050589

§ 371 Date: Dec. 23, 2024

(30) Foreign Application Priority Data
Jun. 27, 2022 (AU) 2022901785

(51) Int. Cl. H01M 50/449; H01M 4/02; H01M 4/134; H01M 4/136; H01M 50/411; H01M 50/491

(52) U.S. Cl. CPC H01M 50/449; H01M 4/134; H01M 4/136; H01M 50/411; H01M 50/491; H01M 2004/027; H01M 2004/028

(57) ABSTRACT

An interlayer for a lithium sulfur battery is provided. The interlayer is produced from an elastic polyelectrolyte liquid (EPL) and a two dimensional conducting material, such as graphene oxide. The EPL is produced from polyphenol, cationic polymer and facilitated ion transport protein. The interlayers are characterised by ion selective transport behaviour and electrocatalytic properties, and separator substrates coated with the interlayer may be usefully incorporated into lithium sulfur batteries.

### FIELD OF THE DISCLOSURE

The present disclosure relates to a permselective interlayer for a lithium sulfur battery. The disclosure also relates to methods of preparing the interlayer, to separators coated with the interlayer, and to lithium-sulfur batteries incorporating the separator.

### BACKGROUND OF THE DISCLOSURE

Lithium-sulfur batteries have received growing attention by both academia and industry in view of their much higher theoretical specific energy density compared to lithium-ion batteries.

However, lithium sulfur batteries face technical challenges which have so far limited their wide spread adoption and commercialisation. These challenges include the insulating nature of solid sulfur as well as the large volume change during charging and discharging which may result in structural damage to the sulfur cathode. Additionally, during the discharge process, intermediate lithium polysulfides (LiPS) are at least partially solublised in the electrolyte and as a result can diffuse from the cathode to the anode and be further reduced by lithium metal to form nonconductive solids. This phenomenon is also known as the Li—S “shuttling effect”.

These nonconductive solids can accumulate on the surface of the lithium metal anode and do not readily transfer from the solid phase back to the liquid phase, which results in continuous cathode active material loss and passivation of the lithium anode, leading to the irreversible capacity loss.

To date, several strategies have been utilized in attempt to tackle the shuttling effect. One strategy includes the provision of physical barriers or interlayers, in an attempt to suppress the shuttling effect. However, as well as providing such suppression, an interlayer should at least maintain fast transport of Lit, and be strongly adhesive to the porous separator substrate, typically a hydrophobic polyolefin.

A need remains for improved interlayers for lithium sulfur batteries that address at least some of the aforementioned issues.

Reference to any prior art in the specification is not an acknowledgment or suggestion that this prior art forms part of the common general knowledge in any jurisdiction or that this prior art could reasonably be expected to be understood, regarded as relevant, and/or combined with other pieces of prior art by a skilled person in the art.

### SUMMARY OF THE DISCLOSURE

In one aspect the present disclosure provides a permselective interlayer for a lithium-sulfur battery comprising:
a) one or more elastic polyelectrolyte liquids; and
b) one or more two dimensional conducting materials.

In embodiments the permselective interlayer comprises:
a) about 15 wt. % to about 45 wt. % of one or more elastic polyelectrolyte liquids; and
b) about 40 wt. % to about 80 wt. % of one or more two dimensional conducting materials;
based on the total weight of the permselective interlayer.

In embodiments the permselective interlayer comprises:
a) about 20 wt. % to about 40 wt. % of one or more elastic polyelectrolyte liquids; and
b) about 40 wt. % to about 80 wt. % of one or more two dimensional conducting materials;
based on the total weight of the permselective interlayer.

In embodiments, the weight ratio of the one or more elastic polyelectrolyte liquids to the one or more two dimensional conducting materials is from about 1:1.5 to about 1:3.5.

In embodiments the elastic polyelectrolyte liquid comprises a mixture of:
a) about 40 wt. % to about 80 wt. % of one or more polyphenols;
b) about 5 wt. % to about 40 wt. % of one or more cationic polymers; and
c) about 5 wt. % to about 35 wt. % of one or more facilitated ion transport proteins;
based on the total weight of the elastic polyelectrolyte liquid.

In embodiments the elastic polyelectrolyte liquid comprises a mixture of:
a) about 50 wt. % to about 80 wt. % of one or more polyphenols;
b) about 15 wt. % to about 40 wt. % of one or more cationic polymers; and
c) about 5 wt. % to about 35 wt. % of one or more facilitated ion transport proteins;
based on the total weight of the elastic polyelectrolyte liquid.

In embodiments, the elastic polyelectrolyte liquid comprises a mixture of:
a) about 50 wt. % to about 70 wt. % of one or more polyphenols;
b) about 15 wt. % to about 35 wt. % of one or more cationic polymers; and
c) about 10 wt. % to about 30 wt. % of one or more facilitated ion transport proteins;
based on the total weight of the elastic polyelectrolyte liquid.

In embodiments, the one or more polyphenols have a molecular weight from about 100 to about 20,000 Daltons, or from about 200 to about 20,000 Daltons.

In embodiments, the one or more polyphenols comprise one or more of tannic acid, caffeic acid, gallic acid, ellagitannin, gallotannin, elagic acid, proanthocyanidins, and curcumin.

In embodiments, the one or more cationic polymers comprise amine functions.

In embodiments, the one or more cationic polymers comprise one or more of polyethylenimine, poly(allylamine) hydrochloride, poly(lysine), poly(DADMAC) and chitosan.

In embodiments, the one or more facilitated ion transport proteins comprise one or more of bovine serum albumin, lysosome, ovalbumin and valinomycin.

In embodiments, the one or more two dimensional conducting materials comprise one or more of reduced graphene oxide, transition metal dichalcogenides, metal-organic frameworks, phosphorenes and nitrides.

The transition metal dichalcogenides may comprise one or more of MX₂, wherein M is Mo, W or V, and X is S, Se or Te.

In embodiments, the permselective interlayer comprises both hydrophilic and hydrophobic domains.

In embodiments, the permselective interlayer has a zero shear viscosity of less than 500 Pa·s measured between 20° C. and 25° C.

In another aspect the present disclosure provides a separator for a lithium-sulfur battery, comprising a porous substrate coated with the permselective interlayer according to any one of the herein disclosed embodiments.

In embodiments, the porous substrate comprises one or more polyolefins.

In embodiments, the permselective interlayer thickness on the separator is from about 100 nm to about 400 nm, or from about 150 nm to about 350 nm, or from about 200 nm to about 300 nm.

In embodiments, the permselective interlayer coating comprises pores of a size sufficiently large to permit the transport of lithium ions through the separator.

In embodiments, the permselective interlayer coating comprises pores of a size sufficiently small to hinder the transport of polysulfide species through the separator. The permselective interlayer coating may hinder the transport of more than 90% of polysulfide species, or more 95%, or up to 99% or more, through the separator.

In embodiments the permselective interlayer coating mitigates the accumulation of polysulfide species on a surface of the permselective interlayer coating.

In another aspect the present disclosure provides a lithium sulfur battery comprising a lithium anode, a sulfur cathode, a separator coated with the permselective interlayer according to any one of the herein disclosed embodiments, and electrolyte disposed between the anode and cathode.

In embodiments, during charging or discharging of the battery, the permselective interlayer coating mitigates the accumulation of polysulfide species on the surface of the permselective interlayer coating.

In embodiments, during charging or discharging of the battery, the permselective interlayer coating oxidises or reduces polysulfide species.

In embodiments, during charging or discharging of the battery, the permselective interlayer coating facilitates the transport of lithium ions through the separator.

In embodiments, during charging or discharging of the battery, the permselective interlayer coating hinders the transport of polysulfide species through the separator.

In embodiments, the permselective interlayer coating hinders the transport of more than 90% of polysulfide species through the separator, or more than 95%, or up to 99%, or greater.

In embodiments, the electrolyte volume to capacity ratio of the lithium sulfur battery is less than or equal to 5 μL mAh-1.

In another aspect the present disclosure provides method of producing a permselective interlayer according to any one of the herein disclosed embodiments comprising combining one or more elastic polyelectrolyte liquids with one or more two dimensional conducting materials.

When the two dimensional conducting material is graphene oxide the combination of one or more elastic polyelectrolyte liquids and graphene oxide is heated to a temperature greater than 60° C., so as reduce at least some of the graphene oxide.

In the method, the weight ratio of the one or more elastic polyelectrolyte liquids to the one or more two dimensional conducting materials is from about 1:1.5 to about 1:3.5.

In another aspect, the present disclosure provides a method of producing a separator according to any one of the herein disclosed embodiments, comprising coating a porous substrate with a permselective interlayer according to any one of the herein disclosed embodiments.

In another aspect, the present disclosure provides an elastic polyelectrolyte liquid comprising a mixture of one or more polyphenols, one or more cationic polymers and one or more facilitated ion transport proteins.

In another aspect, the present disclosure provides a method of preparing an elastic polyelectrolyte liquid according to any one of the herein disclosed embodiments:
a) combining one or more polyphenols and one or more cationic polymers; and
b) adding one or more facilitated ion transport proteins.
   wherein a) and b) are performed under acidic conditions.

Advantages of the presently disclosed permselective interlayer include one or more of the following:
permselective transport of lithium ions;
hinder or eliminate polysulfide transport;
reactivation and recycling of polysulfides;
strong adhesion to a separator substrate.

Any embodiment herein shall be taken to apply mutatis mutandis to any other embodiment unless specifically stated otherwise.

The present disclosure is not to be limited in scope by the specific embodiments described herein, which are intended for the purpose of exemplification only. Functionally-equivalent products, compositions and processes are clearly within the scope of the disclosure, as described herein.

Further aspects of the present disclosure and further embodiments of the aspects described in the preceding paragraphs will become apparent from the following description, given by way of example and with reference to the accompanying drawings.

### BRIEF DESCRIPTION OF THE DRAWINGS

FIG. 1 shows: A) a phase diagram indicating compositional region in which the formation of elastic polyelectrolyte liquid (EPL) is preferred.

FIG. 2 shows: E) zero-shear viscosities; F) polarized microscopy images of EPL-rGO showing domains of liquid crystallinity.

FIG. 3 indicates the relationship between the reduction time, electrical conductivity and coatability for different EPL:GO compositions.

FIG. 4 shows: A) schematic demonstrating the narrow and wide channels of EPL-rGO; B) XRD pattern and C) positron lifetime trace of EPL-rGO.

FIG. 5 shows: A) optical images of the diffusion cells employing different permselective interlayers in Li₂S₄; B) a summary of the LIPS rejection and interlayer spacing characteristics of different permselective materials; C) long-term stability tests of different interlayers for 48 h in a 2 mM solution of Li₂S₆ with solvent and salts.

FIG. 6 shows a plot of interlayer thickness against ionic conductivity and percentage lithium polysulfide rejection.

FIG. 7 shows: A) comparison of permselective interlayers across coin cells assembled with sulfur loading 3.2 mg cm-2; B) CV comparison; C) Nyquist plots of the cells; D) charge/discharge profiles; and E) cycling data at higher rate and F) higher sulfur loading.

FIG. 8 shows: A) pouch cell cycling performance; B) double-sided cathode pouch cell; C) charge-discharge profile of the pouch cell; D) Nyquist plot.

FIG. 9 shows: A) schematic depicting the cell set-ups for ionic conductivity and Li⁺ transference number characterizations; B) summary of results with images of the electrolyte contact angle below; C) proposed mechanism of Li⁺ transport through the EPL-rGO interlayer; D) activation energies obtained from the slope of temperature-dependence of the resistance.

FIG. 10 shows: A) catholyte half-cell set up with EPL-rGO as an electrode in the absence of sulfur; B) demonstrating electrochemical activity of the EPL-rGO separator with CV curves—the presence of pronounced peaks indicates the ability of EPL-rGO to catalyze the electrochemical reactions of different LiPS species.

FIG. 11 shows CV curves of symmetrical cells indicating current response at a polarization between-0.8 and 0.8 V.

FIG. 12 shows symmetrical CV curves comparing EPL-rGO material to other commonly employed redox mediators and electrocatalysts.

FIG. 13 shows a comparison of permselective interlayers across coin cells assembled with sulfur loading 3 mg cm-2 and different combinations of polyphenol, cationic polymers and facilitated ion transport proteins.

### DETAILED DESCRIPTION OF THE EMBODIMENTS

It will be understood that the disclosure described and defined in this specification extends to all alternative combinations of two or more of the individual features mentioned or evident from the text or drawings. All of these different combinations constitute various alternative aspects of the disclosure.

### Definitions

For purposes of interpreting this specification, terms used in the singular will also include the plural and vice versa.

As used herein, except where the context requires otherwise, the term “comprise” and variations of the term, such as “comprising”, “comprises” and “comprised”, are not intended to exclude further additives, components, integers or steps.

“About” as used herein when referring to a measurable value such as an amount, a temporal duration, and the like, is meant to encompass variations of ±20% or ±10%, in some instances ±5%, in some instances ±1%, and in some instances ±0.1% from the specified value, as such variations are appropriate to perform the disclosed methods.

As used herein, the term “polyphenol” refers to a chemical compound having more than one hydroxyl groups on aromatic rings. Accordingly, the term includes compounds such as phenolic acids having more than one hydroxyl groups on aromatic rings.

Ranges: throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

The present disclosure relates to a new permselective interlayer for a lithium sulfur battery. The interlayer facilitates the transport of lithium ions yet mitigates the transport of polysulfide anions. Furthermore, the interlayer advantageously reduces surface accumulation of polysulfide species.

### Permselective Interlayer

The present disclosure provides a permselective interlayer for a lithium-sulfur battery comprising:
a) one or more elastic polyelectrolyte liquids; and
b) one or more two dimensional conducting materials.

In embodiments the permselective interlayer comprises:
a) about 15 wt. % to about 45 wt. % of one or more elastic polyelectrolyte liquids; and
b) about 40 wt. % to about 80 wt. % of one or more two dimensional conducting materials;
based on the total weight of the permselective interlayer.

In embodiments the permselective interlayer comprises:
a) about 20 wt. % to about 40 wt. % of one or more elastic polyelectrolyte liquids; and
b) about 40 wt. % to about 80 wt. % of one or more two dimensional conducting materials;
based on the total weight of the permselective interlayer.

The amount of the one or more elastic polyelectrolyte liquids in the permselective interlayer may be about 15 wt. % to about 45 wt. %, or about 20 wt. % to about 45 wt. %, or about 25 wt. % to about 45 wt. %, or about 30 wt. % to about 45 wt. %.

The amount of the one or more two dimensional conducting materials in the permselective interlayer may be about 40 wt. % to about 80 wt. %, or about 45 wt. % to about 80 wt. %, or about 50 wt. % to about 80 wt. %, or about 55 wt. % to about 80 wt. %, or about 60 wt. % to about 80 wt. %, or about 65 wt. % to about 80 wt. %, or about 70 wt. % to about 80 wt. %, or about 75 wt. % to about 80 wt. %.

In embodiments, the weight ratio of the one or more elastic polyelectrolyte liquids to the one or more two dimensional conducting materials is from about 1:1.5 to about 1:3.5.

### Elastic Polyelectrolyte Liquid

The one or more elastic polyelectrolyte liquids may comprise a mixture of:
a) about 40 wt. % to about 80 wt. % of one or more polyphenols;
b) about 5 wt. % to about 40 wt. % of one or more cationic polymers; and
c) about 5 wt. % to about 35 wt. % of one or more facilitated ion transport proteins;
based on the total weight of the elastic polyelectrolyte liquid.

The one or more elastic polyelectrolyte liquids may comprise a mixture of:
a) about 50 wt. % to about 80 wt. % of one or more polyphenols;
b) about 15 wt. % to about 40 wt. % of one or more cationic polymers; and
c) about 5 wt. % to about 35 wt. % of one or more facilitated ion transport proteins;
based on the total weight of the elastic polyelectrolyte liquid.

The one or more elastic polyelectrolyte liquids may comprise a mixture of:
a) about 50 wt. % to about 70 wt. % of one or more polyphenols;
b) about 15 wt. % to about 35 wt. % of one or more cationic polymers; and
c) about 10 wt. % to about 30 wt. % of one or more facilitated ion transport proteins;
based on the total weight of the elastic polyelectrolyte liquid.

Suitable polyphenols may be chosen from polyphenols having a molecular weight from about 100 to about 20,000 Daltons, or from about 200 to about 20,000 Daltons.

Exemplary polyphenols may comprise one or more of tannic acid, caffeic acid, gallic acid, ellagitannin, gallotannin, elagic acid, proanthocyanidins, and curcumin. Other polyphenols are contemplated.

Suitable cationic polymers may comprise amine functions. Exemplary cationic polymers may comprise one or more of polyethylenimine, poly(allylamine) hydrochloride, poly(lysine), poly(DADMAC) and chitosan. Other cationic polymers are contemplated.

Exemplary facilitated ion transport proteins comprise one or more of bovine serum albumin, lysosome, ovalbumin and valinomycin. Other facilitated ion transport proteins are contemplated.

The elastic polyelectrolyte liquids may be prepared by combining one or more polyphenols, one or more conducting polymers and one or more facilitated ion transport proteins.

Preferably the elastic polyelectrolyte liquids may be prepared by first combining one or more polyphenols and one or more cationic polymers; and subsequently adding one or more facilitated ion transport proteins.

Preferably, the elastic polyelectrolyte liquids are prepared under acidic conditions.

### Characteristics of Elastic Polyelectrolyte Liquids

On combination of the one or more polyphenols, one or more cationic polymers, and one or more facilitated ion transport proteins, a dense phase and clear supernatant may be formed, and such a mixture is conducive to self-assembly with one or more two dimensional conducting materials.

In one embodiment, the polyphenol is tannic acid, the cationic polymer is polyethylenimine, and the facilitated ion transport protein is bovine serum albumin. In an example, suitable elastic polyelectrolyte liquids may be prepared by combining tannic acid, polyethylenimine and bovine serum albumin in a weight ratio of about 60:25:15. Such a composition has a surface charge as determined by zeta potential of about +40 mV. Fourier Transform Infrared spectroscopy indicated the presence of phenol, amine, carboxyl, carbonyl, and amide stretching modes.

In another embodiment, the polyphenol is caffeic acid, the cationic polymer is polyethylenimine, and the facilitated ion transport protein is bovine serum albumin. In an example, suitable elastic polyelectrolyte liquids may be prepared by combining caffeic acid, polyethylenimine and bovine serum albumin in a weight ratio of about 60:15:25.

In another embodiment, the polyphenol is gallic acid, the cationic polymer is polyethylenimine, and the facilitated ion transport protein is bovine serum albumin. In an example, suitable elastic polyelectrolyte liquids may be prepared by combining gallic acid, polyethylenimine and bovine serum albumin in a weight ratio of about 60:15:25.

In another embodiment, the polyphenol is tannic acid, the cationic polymer is pDADMAC, and the facilitated ion transport protein is bovine serum albumin. In an example, suitable elastic polyelectrolyte liquids may be prepared by combining tannic acid, pDADMAC and bovine serum albumin in a weight ratio of about 60:15:25.

In another embodiment, the polyphenol is tannic acid, the cationic polymer is polyethylenimine, and the facilitated ion transport protein is lysosome. In an example, suitable elastic polyelectrolyte liquids may be prepared by combining tannic acid, polyethylenimine and lysosome in a weight ratio of about 60:15:25.

### Two Dimensional Conducting Material

The one or more two dimensional conducting materials may comprise one or more of reduced graphene oxide, transition metal dichalcogenides, metal-organic frameworks, phosphorenes, and nitrides. Other two dimensional conducting materials are contemplated.

Exemplary transition metal dichalcogenides may comprise one or more of MX₂, wherein M is Mo, W or V and X is S, Se or Te, for example MoS₂, MoTe₂, and VS₂.

### Preparation of Permselective Interlayer

The permselective interlayers may be prepared by combining one or more elastic polyelectrolyte liquids and one or more two dimensional conducting materials.

Preferably, the weight ratio of the one or more elastic polyelectrolyte liquids to the one or more two dimensional conducting materials is from about 1:1.5 to about 1:3.5.

In embodiments where the two dimensional conducting material comprises graphene oxide the mixture of one or more elastic polyelectrolyte liquids and one or more two dimensional conducting materials is heated to a temperature greater than 60° C., preferably to about 80° C., to convert at least some of the graphene oxide to reduced graphene oxide.

Heating may be performed from about 1 hour to about 36 hours, preferably from about 8 hours to about 20 hours

### Properties of Permselective Interlayer

The presently disclosed elastic polyelectrolyte liquid when combined with the two dimensional conducting material imparts advantageous properties to the permselective interlayer. The elastic polymeric liquid improves ion transport, and enhances coatability and adhesion to separator substrates. Additionally, when the two dimensional conducting material is graphene oxide, the elastic polyelectrolyte liquid reduces at least some of the graphene oxide to reduced graphene oxide.

In embodiments, the permselective interlayer comprises both hydrophilic and hydrophobic domains.

In embodiments, the permselective interlayer has a zero shear viscosity of less than 500 Pa·s measured between 20° C. and 25° C.

In one embodiment, wherein the elastic polyelectrolyte liquid is formed from a mixture of tannic acid, polyethylenimine, and bovine serum albumin in a weight ratio of about 60:25:15, a suitable permselective interlayer may be produced by combining this mixture in a weight ratio of about 1:2 with graphene oxide. On combining, gelation occurs, likely due to various interactions between the elastic polyelectrolyte liquid and the graphene oxide, such as IT-TT, hydrogen and Coulombic interactions. This is supported by the observation that the zero-shear viscosities of graphene oxide and the elastic polyelectrolyte liquid of respectively 45 Pa·s and 4 Pa·s increased to 980 Pa·s after gelation and the material has a surface charge of +30 mV. Heating to 80° C. for a range of times to reduce the graphene oxide yields the permselective interlayer with a zero-shear viscosity of 250 Pa·s and a surface charge of +37 mV.

### Separators

Porous separators such as Celgard polyolefin separators are utilized in battery systems owing to their inert nature and excellent stability. However, one shortcoming is their hydrophobic nature which is unfavourable for coating modifications.

An advantageous feature of the presently disclosed permselective interlayers is that casting on a hydrophobic surface such as a Celgard surface is made possible due to the amphiphilicity and excellent adhesion properties of polyphenol and facilitated ion transport protein components, that is, due to the presence of both hydrophilic and hydrophobic domains in the interlayer.

### Method of Making Separator

A porous separator substrate, such as Celgard, may be coated with the presently disclosed permselective interlayer on one surface or both surfaces of the porous substrate.

The method for preparing the separator of the present disclosure is not particularly limited, and known methods or various methods modifying these methods may be used by those skilled in the art.

In one method, the presently disclosed permselective interlayer is prepared, and then coated on at least one surface of a porous substrate and then dried.

Useful porous separator substrates include polymers, such as polyarylate, polyethylene terephthalate, polybutylene terephthalate, polysilane, polysiloxane, polysilazane, polyethylene, polycarbosilane, polyacrylate, poly(meth) acrylate, polymethyl acrylate, polymethyl(meth) acrylate, polyethyl acrylate, a cyclic olefin copolymer, polyethyl(meth) acrylate, a cyclic olefin polymer, polypropylene, polyimide, polystyrene, polyvinyl chloride, polyacetal, polyetheretherketone, polyestersulfone, polytetrafluoroethylene, polyvinylidene fluoride, a perfluoroalkyl polymer and the like. Preferred porous substrates include polyolefins, such as polyethylene or polypropylene.

The coating process may be controlled to provide a permselective interlayer thickness on the porous substrate from about 100 nm to about 400 nm, or from about 150 nm to about 350 nm, or from about 200 nm to about 300 nm.

### Separator Performance

A permselective interlayer in a lithium sulfur battery may advantageously have pore sizes smaller than lithium polysulfide (LiPS) but also permit Li⁺ transport. The subnanometer pores required to block or hinder LiPS transport are a fundamental limitation in a Li—S battery because of the significant mass transport resistance which may be imposed on Li⁺ transport. Such Li⁺ transport facilitates electrochemical reactions, and their impediment may result in low active material utilization, concentration polarization, low CE and high cell resistances.

Another limitation is that these hindered LiPS species may eventually accumulate on the interlayer surface, i.e. causing interlayer fouling and pore clogging. This may lead to active material losses, high microviscosity on the interlayer surface, surface passivation and may create a feedback loop of deteriorating ion transport.

During cell operation, there are numerous different LiPS species present in the electrolyte. Due to the low dielectric constant of the ether solvents (ε˜7) and high ionic concentration of Li⁺ salts in the electrolyte [Li⁺]≥1M, the dominant species are neutral ion triplets [Li₂Sn] and their clusters [Li₂Sn]ₓ, while lone ion pairs [Li₂Sn] and [Sn] are negligible. Among these many species, Li₂S₄ is the most dominant species generated during operation, as the reduction of Li₂S₄ to Li₂S comprises ˜75% of the theoretical cell capacity.

Permselective interlayers may desirably have redox-mediating properties or electrocatalytic surfaces to ‘re-activate’ and ‘re-cycle’ these accumulated LiPS species by promoting their conversion kinetics, while at the same time, mitigating the irreversible deposition of Li₂S.

The presently disclosed permselective interlayers address these issues. They demonstrate an ability to retain or hinder the transport of LiPS species while allowing Li ion transport, and also minimize surface accumulation of LiPS species by ‘re-activating’ them due the redox-mediating property of the permselective interlayer.

In embodiments, the herein disclosed separators may hinder more than 90% LiPS transfer through the separator, or more than 95%, or up to 99% LiPS transfer rejection.

In embodiments, the herein disclosed separators oxidise and reduce LiPS on the surface of the permselective interlayer. Accordingly, accumulation of LiPS on the surface is reduced or eliminated.

### Lithium-Sulfur Batteries

The present disclosure provides a lithium sulfur battery comprising a lithium anode, a sulfur cathode, a separator according to any one of the herein disclosed embodiments, and electrolyte disposed between the anode and cathode.

The selection of lithium anode is not particularly limiting. It may be lithium metal or a lithium alloy. Herein, the lithium alloy comprises elements capable of alloying with lithium, and the element may be Si, Sn, C, Pt, Ir, Ni, Cu, Ti, Na, K, Rb, Cs, Fr, Be, Mg, Ca, Sr, Sb, Pb, In, Zn, Ba, Ra, Ge, Al, Co or an alloy thereof.

The selection of the sulfur cathode is not particularly limiting. It may comprise elemental sulfur, sulfur compounds used in the art of constructing sulfur cathodes, or mixtures thereof.

The sulfur cathode may comprise a conductor. Commonly used conductors include graphite, carbon black, carbon fiber, carbon nanotubes and the like.

The sulfur cathode may also include a binder. However the binder is not limited and binders typically used in the art of sulfur cathode construction may be used.

The electrolyte of the lithium sulfur battery is a lithium-salt containing electrolyte liquid, and may be an aqueous or non-aqueous electrolyte liquid, and is preferably a non-aqueous electrolyte formed with an organic solvent electrolyte liquid and a lithium salt. In addition, an organic solid electrolyte, an inorganic solid electrolyte or the like may be utilised, however, the electrolyte liquid is not limited thereto.

Examples of the non-aqueous organic solvent may comprise aprotic organic solvents such as N-methyl-2-pyrrolidinone, propylene carbonate, ethylene carbonate, butylene carbonate, dimethyl carbonate, diethyl carbonate, ethylmethyl carbonate, gamma-butyrolactone, 1,2-dimethoxyethane, 1,2-diethoxyethane, tetrahydrofuran, 2-methyltetrahydrofuran, dimethyl sulfoxide, 1,3-dioxolane, 4-methyl-1,3-dioxane, diethyl ether, formamide, dimethylformamide, dioxolane, acetonitrile, nitromethane, methyl formate, methyl acetate, phosphoric acid triester, trimethoxymethane, dioxolane derivatives, sulfolane, methylsulfolane, 1,3-dimethyl-2-imidazolidinone, propylene carbonate derivatives, tetrahydrofuran derivatives, ether, methyl propionate or ethyl propionate.

The lithium salt is a material favorably dissolved in the non-aqueous electrolyte, and examples thereof may comprise LiCl, LiBr, LiI, LiNO₃, LiClO₄, LiBF₄, LiB₁₀Cl₁₀, LiPF₆, LiCF₃SO₃, LiCF₃CO₂, LiAsF₆, LiSbF₆, LiAlCl₄, CH₃SO₃Li, CF₃SO₃Li, LiSCN, LiC(CF₃SO₂)₃, (CF₃SO₂)₂NLi, (FSO₂)₂NLi, chloroborane lithium, lower aliphatic carboxylic acid lithium, lithium tetraphenylborate, lithium imide and the like.

In embodiments, the lithium-sulfur batteries of the present disclosure have sulfur loadings of greater than 3 mg cm⁻², or greater than 6 mg cm⁻².

In embodiments, the lithium-sulfur batteries of the present disclosure have an electrolyte volume to capacity ratio of less than or equal to 5 μL mAh⁻¹.

### Lithium Sulfur Battery Performance

Coin cells including the herein disclosed separator achieve areal capacities of 4.8-8.1 mAh cm⁻² with 450 stable cycles with very low electrolyte/capacity (E/C) ratios of 4.9-5.3 μL mAh⁻¹.

Pouch cell prototypes (3 cm×5 cm) including the herein disclosed separator achieve an energy density of 202 Wh kg-1 over 100 stable cycles.

### EXAMPLES

### Materials

Sulfur cathodes were comprised of crystalline sulfur (Sigma Aldrich), carbon (Black Pearls 2000, CABOT Co.) and carboxymethylcellulose binder (Sigma). The elastic polyelectrolyte liquid (EPL) was comprised of tannic acid (Sigma), polyethylenimine (Mn1000, Sigma) and Bovine Serum Albumin (Heat Shock Fraction, Sigma). Graphene oxide paste (The Sixth Element Inc.) was purified and exfoliated, and made into a suspension by the addition of deionized water.

Bis(trifluoromethane) sulphonamide lithium salt and lithium nitrate were purchased from Sigma-Aldrich and directly used without any further purification. Dimethoxyethane (DME) and 1,3-dioxolane (DOL) solvents were purchased from Sigma. Li₂S was purchased from Alfa Aesar for lithium polysulfide synthesis. Battery grade etched Al foil was purchased from Japan Capacitor Industrial Co. and Celgard 2730 was purchased from Celgard Inc., USA.

### Example 1: Preparation of Elastic Polyelectrolyte Liquid (EPL)

Elastic polyelectrolyte liquids (EPL) were synthesised by combining different ratios of the components. A solution of tannic acid (TA) was stirred vigorously at 1000 rpm, followed by the addition of polyethylenimine (PEI), then Bovine Serum Albumin (BSA), at a rate of 1 mL min⁻¹ until the desired ratios were achieved. All EPL samples were prepared at a pH 5 to prevent or minimise any covalent reactions which may occur at basic conditions, such as Michael addition reactions.

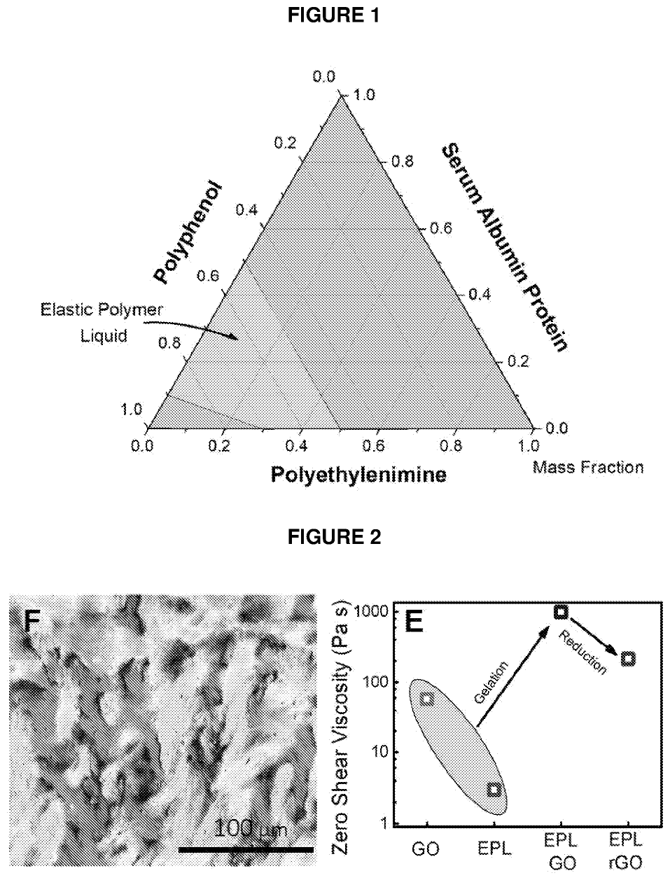

Variation of the TA:PEI:BSA ratios indicated the component ratios wherein preferred EPLs were formed. FIG. 1 illustrates this for a TA:PEI:BSA system highlighting the area of EPL preference.

The amphiphilicity of EPL was demonstrated by its ability to make stable oil-in-water emulsion with paraffin oil and water (30 vol % oil). This suggested that the hydrophobic domains of EPL were able to interact with the paraffin oil, while the hydrophilic domains of EPL interacted with water to create a stable solution of the otherwise immiscible phases.

### Example 2: Preparation of Interlayer Comprising EPL and Reduced Graphene Oxide

EPL was added to a suspension of graphene oxide (GO) at a given mass ratio and stirred vigorously. Gelation was observed after 15 min. For all EPL-GO mixtures, stirring was carried out overnight. For reduction, the EPL-GO suspension was then heated to 80° C. for different times to produce elastic polyelectrolyte liquid-reduced graphene oxide (EPL-rGO) for subsequent use as an interlayer.

### Example 3: Variation of Interlayer Component Amounts

Several EPL-rGO interlayer samples were prepared with different component amounts. Table 1 collects the details and ranks the samples in terms of several performance parameters. Each EPL composition was mixed with graphene oxide at a weight ratio of 1:2 (EPL:GO) and reduced at 70° C. for 12 hours. The relative sheet resistance was taken as a proxy for the degree of GO reduction. Amphiphilicity, as a measure of the degree to which it was useful to coat the hydrophobic surface of Celgard, was estimated by the coatability of the material on bare Celgard. Permselectivity was evaluated by a diffusion cell test. Ionic conductivity was measured by Electrochemical Impedance Spectroscopy (EIS).

TABLE 1

| EPL Composition | GO | Ionic | Amphi- | Permselec- |
|---|---|---|---|---|
| (TA:PEI:BSA) | reduction | Conductivity | philicity | tivity |
| 60:30:10 | Excellent | Excellent | Good | Good |
| 60:25:15 | Excellent | Excellent | Excellent | Excellent |
| 60:20:20 | Good | Good | Excellent | Excellent |
| 60:10:30 | Good | Good | Excellent | Excellent |
| 65:30:5 | Excellent | Excellent | Good | Poor |
| 70:20:10 | Excellent | Good | Excellent | Good |

The results suggest that i) the reduction of GO may be attributed to predominantly TA, but also PEI, ii) all components may contribute to ameliorate ion transport, most notably BSA, however with diminishing returns after exceeding a certain fraction; iii) Li⁺ affinity may be associated with PEI content; iv) favourable adhesion properties may be derived from BSA and TA; v) permselectivity may be attributed to BSA content. These results are further discussed in the following paragraphs.

### Example 4: Characterisation of EPL-rGO Interlayers

FIG. 2F is a brightfield polarized microscopy image of the EPL-rGO of Example 3 (60:25:15 EPL composition) which shows domains of liquid crystallinity. This suggests that even after reduction, a high degree of structural order remained. FIG. 2E shows the variation in viscosity of EPL, GO, the combination of EPL and GO, and EPL-rGO. It can be seen that on combining EPL with GO there is a significant increase in zero-shear viscosity which is line with the observed gelation. On reduction, zero-shear viscosity decreases.

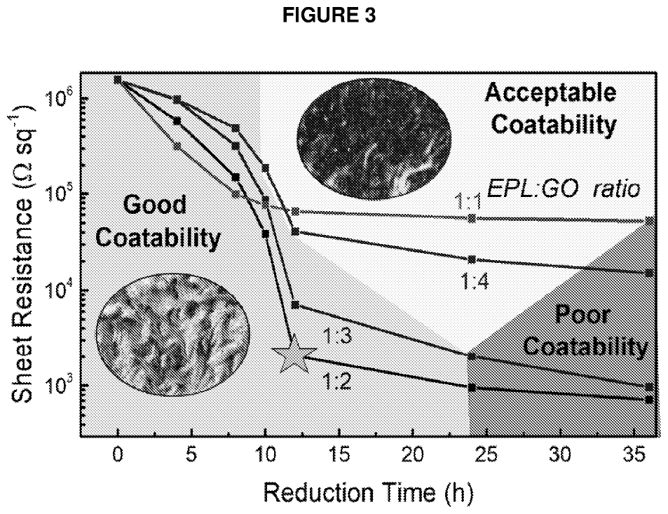

Reduction of EPL-GO to EPL-rGO was further evidenced by increasing electrical conductivity with respect to reduction time (see FIG. 3). It can be seen that long reduction times can have a negative effect on EPL-rGO coatability. Over-reduction may lead to the formation of particulate material which diminishes performance as an interlayer material. Reduction was further supported by Fourier Transform Infrared (FTIR) spectroscopy which indicated a decrease in the intensity of peaks associated with C—O and C═O bonds and X-ray Spectroscopy (XPS) which indicated decreased relative intensity of sp2 to sp3 domains, indicating deoxygenation of GO. Raman spectroscopic studies indicated a shift in the G band in the spectra to lower frequencies (redshift) from EPL-GO to EPL-rGO, further supporting reduction.

EPL-rGO also maintained long term colloidal stability as evidenced by its stability even after 3 months of storage at ambient temperature.

### Example 5: Separator Preparation

EPL-GO, EPL-rGO and rGO were coated on Celgard. However, for comparison between the permselective interlayers, the coatability of Celgard was improved by dip-coating in a 15 g L⁻¹ solution of tannic acid for 15 min, thereby endowing hydrophilicity, and this hydrophilised Celgard was utilized for all experiments. Coating was carried out by rod coating. The rGO interlayers were reduced by UVC light (254 nm). The exposure time was tuned to attain a similar thin film resistance to EPL-rGO, at about 220 min.

### Example 6: Studies on EPL-rGO Interlayers

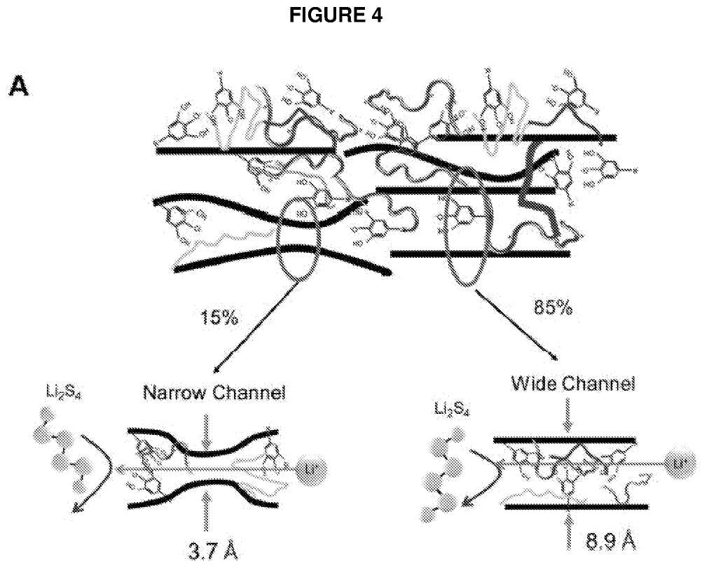

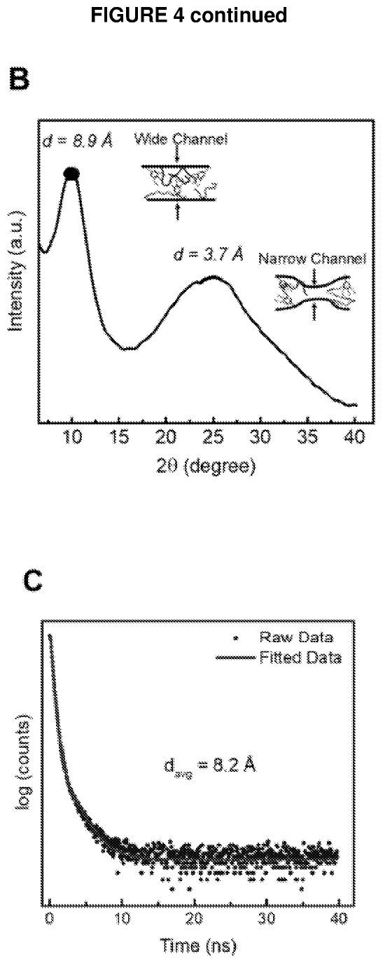

The cut-off for molecular rejection of LIPS is around 9 Å. By tuning the degree of reduction and the ratio of EPL to GO, it is possible to manipulate interlayer spacing to meet this design criteria. X-ray Diffraction (XRD) shows two peaks for EPL-rGO indicating the presence of dual channel spacing with a wide channel of 8.9 Å and a narrow channel of 3.7 Å (FIG. 4B). It should be noted that the differences between the wet state and dry state spectra are minimal, indicating negligible changes in interlayer spacing when EPL-rGO is soaked in solvent for 24 hours. The narrow channels arise from domains of highly reduced and stacked lamella, i.e. regions of sp2 carbon stacking between graphitic regions of lamella, while the wider channels are a result of EPL intercalation into the lamella. This is schematically depicted in FIG. 4A. Positron Annihilation Lifetime Spectroscopy (PALS) analysis revealed an average interlayer spacing as 8.2 Å from the spectrum in FIG. 4C, meaning that ˜15% of channels are narrow and ˜85% of the channels are wide. Both the narrow and wide channels reject LiPS, but the wider channels enable increased Li⁺ permeation.

### Example 7: Rejection Performance of Interlayers

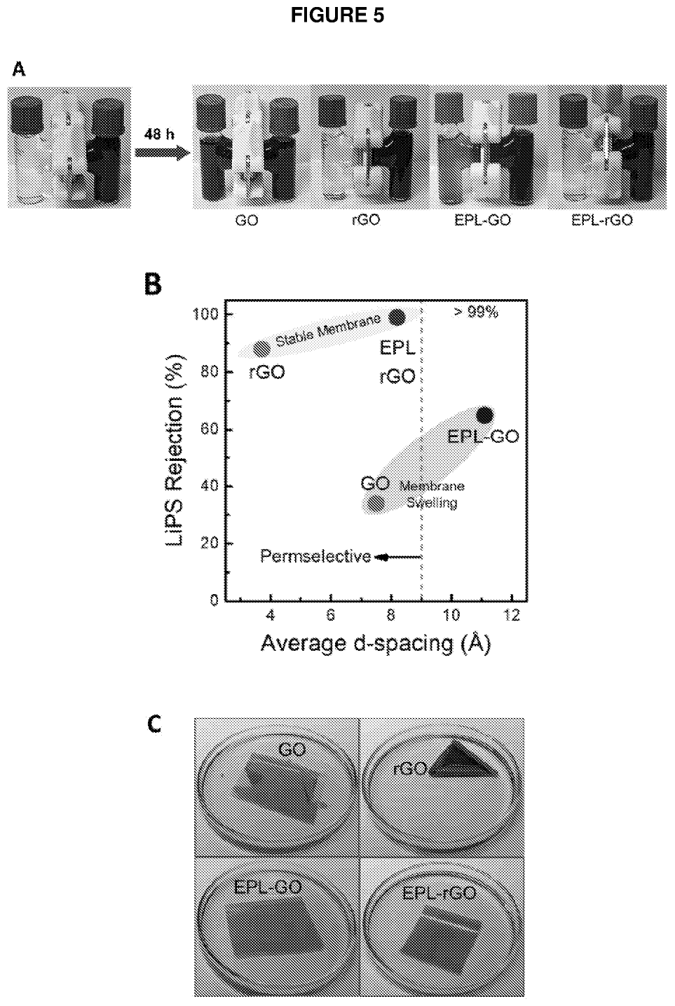

The rejection performance of interlayers was studied in a diffusion cell with Li₂S₄ dissolved in DOL/DME on one side of the cell, and DOL/DME on the other side, as illustrated in FIG. 5A. The synthesis of Li₂S₆ and Li₂S₄ solutions followed the method reported by Liao et al., J. Mater. Chem., vol. 4, pp. 5406-5409, 2016. Elemental sulfur and Li₂S powder were mixed in a solvent of DOL and DME (DOL/DME=50/50 (v/v)) at 50° C. for 48 h under stirring in an argon glove box with appropriate molar ratios. The resulting solution was centrifuged at 5000 rpm for 10 min and any unreacted particles were removed.

Quantification of Li₂S₄ by UV-Vis spectroscopy revealed that the EPL-rGO interlayers were able to reject 99% of Li₂S₄, while GO and rGO interlayers achieved 32% and 91% respectively, and EPL-GO had a rejection of 79%. A visual summary of the results is provided in FIG. 5B.

The rejection performance relies not only on the lamellar interlayer spacing, but also on the stability in the harsh electrolyte and LiPS environment during operation as shown in FIG. 5C. The interlayers coated on Celgard were dipped in a 2 mM solution of Li₂S₆ for 48 h in the presence of LiTFSI and LiNO₃ to simulate the environment of a Li—S battery. Under the solvated conditions, the GO coating lost structural integrity. The rGO coating displayed poor conformational stability and the separator curled after 48 h. EPL-GO, while displaying improvement in remaining anchored to the underlying substrate, had a dry interlayer spacing of 11.1 Å which is slightly above the threshold for LiPS rejection. The strong interactions between EPL and rGO, and the strong interlaminar interactions between the narrow channels, i.e. the strong TT-TT stacking between sp2 domains of rGO are likely important to maintaining structural integrity and mitigating swelling in solvent.

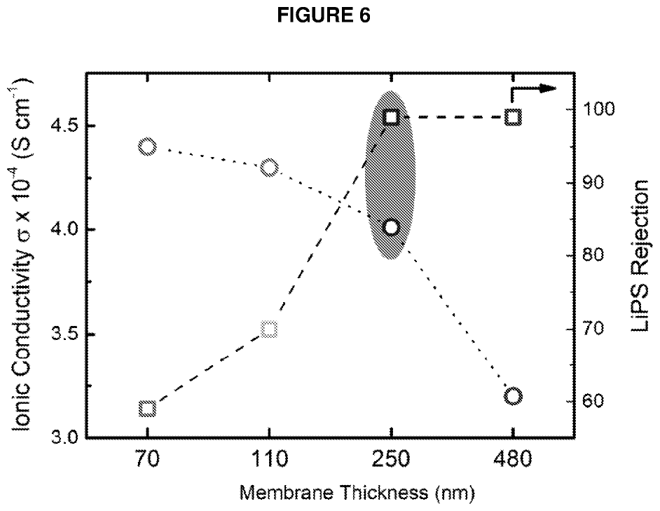

The thickness of the EPL-rGO interlayer coated on Celgard was varied between 70 and 480 nm. FIG. 6 is a plot of interlayer thickness against ionic conductivity and lithium polysulfide rejection. Higher interlayer thickness resulted in higher polysulfide rejection, however ionic conductivity is negatively influenced. Interlayer thickness of around 250 nm gave a useful balance between the ability to reject LiPS, while maximising ionic conductivity.

Diffusion cell studies were undertaken by placing the desired separator between two chambers of a diffusion cell, one side with 0.3 M Li₂S₄ and the other with blank solvent and allowed to permeate for 48 h. The polysulfide rejection values were calculated as

$$R ( \% ) = \frac{{C}_{b} - {C}_{i}}{2 {C}_{b}} \times 100 \%$$

where C_{b} is the concentration on the blank side at time t (48 h) and Cᵢ is the initial concentration on the LiPS side. To test the stability of the different separators, they were dipped in a 0.05 M Li₂S₄ catholyte with LiTFSI and LiNO₃ for 48 h. The diffusion cell testing Li⁺ diffusive flux was set up with one side with electrolyte and the other with blank solvent. The diffusive flux D_{Li}_{⁺} was calculated by:

$${D}_{Li}^{+} = \frac{{n}_{t}}{At}$$

where nₜ is the amount of permeated Li⁺ after 24 h in mmol, through a separator of effective area A (m²) for a total of time t (hr).

### Example 8: Battery Manufacture and Electrochemical Characterisation

The cathode was composed of 70 wt % sulfur, 20 wt % carbon black and 10 wt % CMC binder made into a thick aqueous slurry and tape cast with a doctor blade onto an Al-foil current collector. The cathode was air-dried for 2 hours and further dried in a vacuum oven at 50° C. overnight. The cathodes were then cut into 1 cm² disks. CR2032 coin cells were assembled in an Ar-filled glove box with O₂ and moisture <0.1 ppm using a Li metal anode, aforementioned cathode and separators with different permselective interlayer coatings. For electrochemical characterisations, the galvanostatic charge and discharge method (same charge/discharge current) was applied in the voltage range of 1.8-2.7 V vs. Li/Li⁺ using Neware battery cycler (Neware Technology Limited). Cyclic Voltammetry (CV) was carried out on EC-Lab (BioLogic Science Instruments, France) at different scan rates and a voltage range of 1.8-2.8 V vs. Li/Li⁺. Electrochemical Impedance Spectroscopy (EIS) was also carried out using EC-Lab, measuring responses over frequencies between 1 MHz and 10 mHz, recording six points per decade of frequency. Impedance was repeated three times to ensure reproducibility. The diffusion coefficient D_{Li}_{⁺} was calculated according to the Randles-Ševčík equation, where the measured current of different CV curves obeys a power-law relationship with the scan rate:

$${I}_{p} = 2.69 \times {10}^{5} {n}^{1.5} {A ( {D}_{L i}^{+} )}^{0.5} {C}_{Li} {υ}^{0.5}$$

where Iₚ is the current peak (A), n is the number of electrons in the redox reaction (n=2), A is the electrode area (cm²),

$${D}_{Li}^{+}$$

is the Li⁺ diffusion coefficient (cm² s⁻¹), C_{Li} is the concentration of Li⁺ in electrolyte (mol mL⁻¹) and the scanning rate is ν (V s⁻¹). Pouch cells were manufactured by making 3.3×5.3 cm² cathodes on Al substrate at a loading of 3 mg cm⁻², double-sided. The Li anode (foil, 0.1 mm thickness) was cut to 3.5×5.5 cm². The EPL-rGO coated separator was placed between the two electrodes, with the EPL-rGO facing the cathode. Electrolyte was added to meet the condition E/S ratio=5. The cycling performance was carried out using BT-Lab and EIS was carried out using EC-Lab. The gravimetric specific energy density was calculated according to the follow equation:

$${E}_{g} = \frac{{Vm}_{A} {C}_{s}}{\sum {m}_{i}}$$

where V is the average cell voltage, taken as 2.1 V, mₐ is the mass of active material, Cₛ is the specific capacity and Σmᵢ is the sum of all component masses including the cathode, anode, separator and electrolyte. The calculated energy density was in line with the values reported on BT-Lab software.

### Example 9: Coin Cell Performance

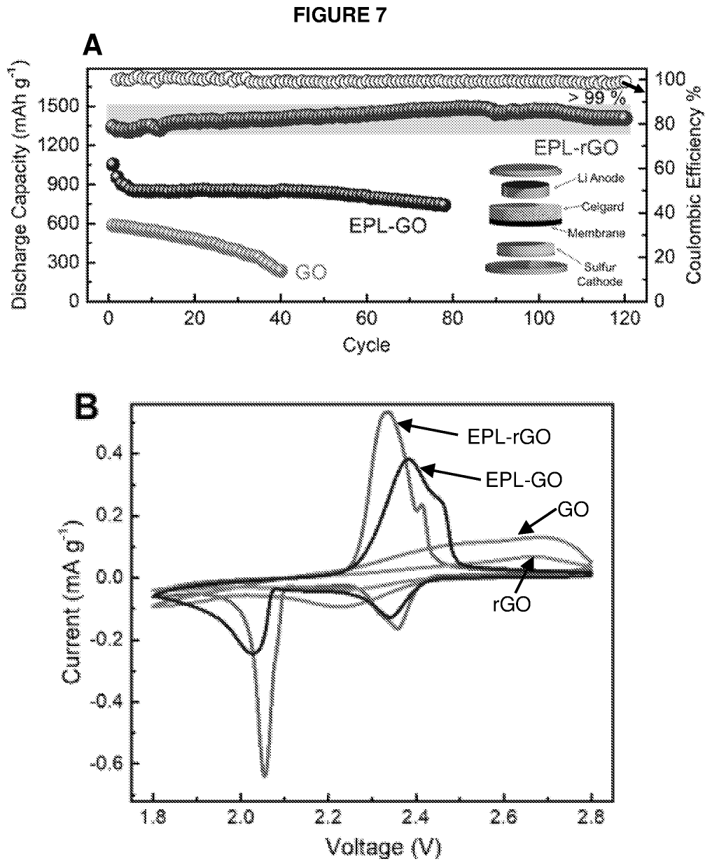

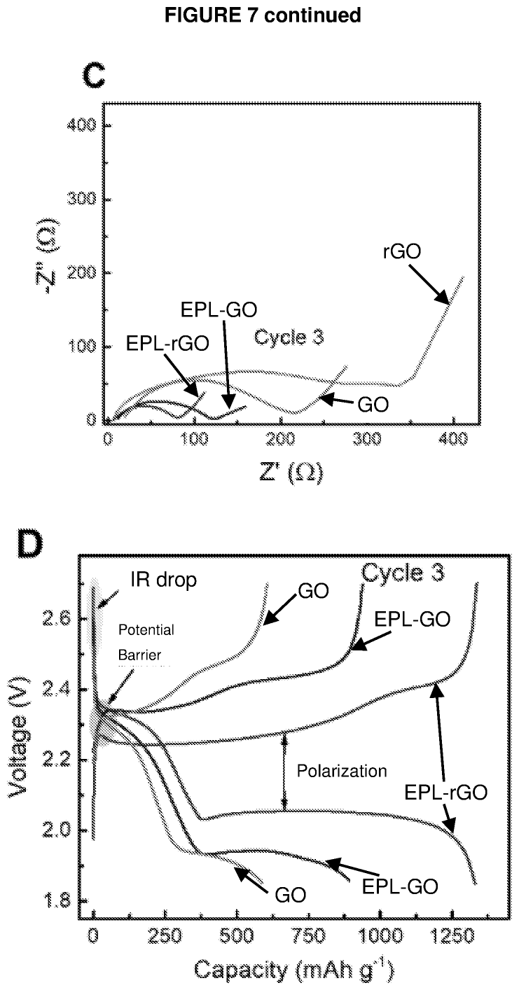

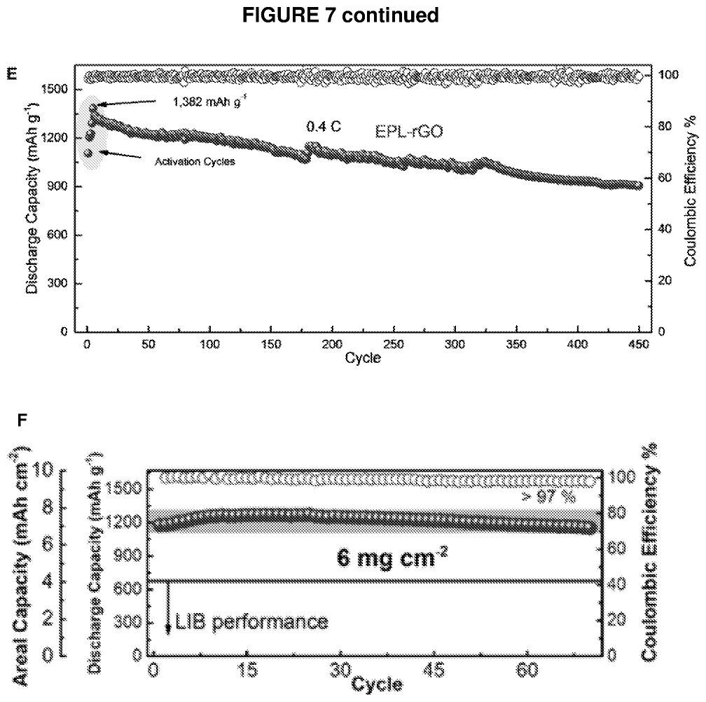

A standard cathode was employed, comprised of sulfur, conductive carbon additive and a water-soluble binder, and was used consistently across the studies. At a sulfur loading of 3.2 mg cm⁻² and a cycling rate of 0.1 C, the cycling performance of different separators with the same thickness of interlayer coating and E/S ratio was compared (see FIG. 7A). The EPL-rGO interlayers indicated minimal capacity decay over 120 cycles with a maximum capacity of 1,505 mAh g⁻¹ (90% sulfur utilization) and CE>99%. EPL-GO, contrastingly, had a significantly lower capacity of 1,102 mAh g⁻¹ and 80 stable cycles before the onset of rapid capacity decay. The cell employing EPL-rGO was able to maintain excellent cycling stability with no capacity loss at high sulfur utilization (>1400 mAh g⁻¹). The bare GO interlayer gave very low initial capacity and limited cycle life.

Electrochemical characterizations were employed to further study the differences in performance. These included cyclic voltammetry (CV), electrochemical impedance spectroscopy (EIS) and analysis of galvanostatic charge-discharge curves.

CV was employed to gain an insight into the electrochemical processes that occur during the anodic and cathodic processes, and allowed for a comparison of reaction kinetics. FIG. 7B indicates that the EPL-rGO interlayer had anodic peaks at 2.41 V and 2.33 V and cathodic peaks at 2.37 V and 2.06 V. Compared to the other interlayers, the peaks are sharper and exhibit higher peak current density, with significantly higher cathodic reaction potentials and lower anodic potentials. The position of the peaks and the high current densities suggest that the EPL-rGO interlayer has superior ion transport properties, accelerated redox kinetics of lithium polysulfide (LiPS) reactions and may effectively suppress LiPS shuttling.

Galvanostatic charge-discharge curves in FIG. 7D complement the CV data. The voltage range of the plateaus and their respective capacity is governed by the access of Li⁺ ions in the cathode, kinetics of LiPS conversion and the ability to mitigate LiPS shuttling. For the EPL-rGO interlayer, the onset of the second plateau is at 2.05 V and 380 mAh g⁻¹ which indicates the availability of Li⁺ in the cathode and fast ion transport and fast redox reactions of higher order LiPS. The length of the second plateau, which is the main contributor to capacity, extends over 950 mAh g⁻¹, suggesting excellent LiPS retention and ability to catalyze the reactions of lower order LiPS to Li₂S.

The distinctly larger potential barriers in the initial stages of the charging process for GO, rGO and EPL-GO interlayers revealed that a high overpotential is required to convert the insulating Li₂S discharge product to LiPS, and the absence of redox-mediation property results in retarded diffusion kinetics. Furthermore, the notably lower polarization when employing EPL-rGO as an interlayer further suggests the combined effects of shuttle suppression, excellent ion transport and a significant ability to enhance LiPS conversion reactions. The higher polarization for the other interlayers is likely a combination of poor ion transport and the concentration polarization of LiPS on their surface. The Internal Resistance (IR) drop at the onset of the discharge profiles for each interlayer, a consequence of ohmic and concentration polarization, is significantly lower for the EPL-rGO interlayer.

The dynamics of ion transport and LiPS regulation was further investigated using Electrochemical Impedance Spectroscopy (EIS) to compare the internal cell resistances. The Nyquist plots are shown in FIG. 7C. The plots are composed of a semicircle in the high-frequency region, the diameter of which can be assigned as the charge-transfer resistance, and an inclined line in the low frequency domain (Warburg impedance) which is related to the capacity fading and electrochemical response. EIS results complement the findings from CV curves and the charge-discharge curves. The reduced internal resistance of EPL-rGO is likely a result of the favourable architecture for ion transport, lithiophilicity and its ability to act both as an upper current collector due to its electronic conductivity and a redox-mediator to propel LiPS conversion reactions.

At a higher cycling rate of 0.4 C, a maximum capacity of 1,382 mAh g⁻¹ was achieved after several activation cycles, exhibiting more than 98.5% CE with around 450 stable cycles as shown in FIG. 7E. At a considerably higher sulfur loading of 6 mg cm⁻², an areal capacity>7 mAh cm⁻² was maintained for 70 cycles at a rate of 0.1 C (attaining a maximum at 8.1 mAh cm⁻²) with minimal capacity loss at the very low electrolyte to capacity (E/C) ratio of 4.9 μL mAh⁻¹ (FIG. 7F).

Electrochemical Impedance Spectroscopy (EIS) studies indicated that internal cell resistances decrease with cycle number, demonstrating the high reversibility of the battery, with a small observed increase after 300 cycles. CVs were conducted at four different scan rates, demonstrating strong current responses and suggesting excellent reaction kinetics The measured current obeyed a power-law relationship with the scan rate which, according to the Randles-Ševčík equation, is related to the Li+ diffusion coefficient, D_Li\hat{ }+. The D_Li\hat{ }+ of the full cell is in the order of 10⁻⁹ cm²s⁻¹.

### Example 10: Pouch Cells

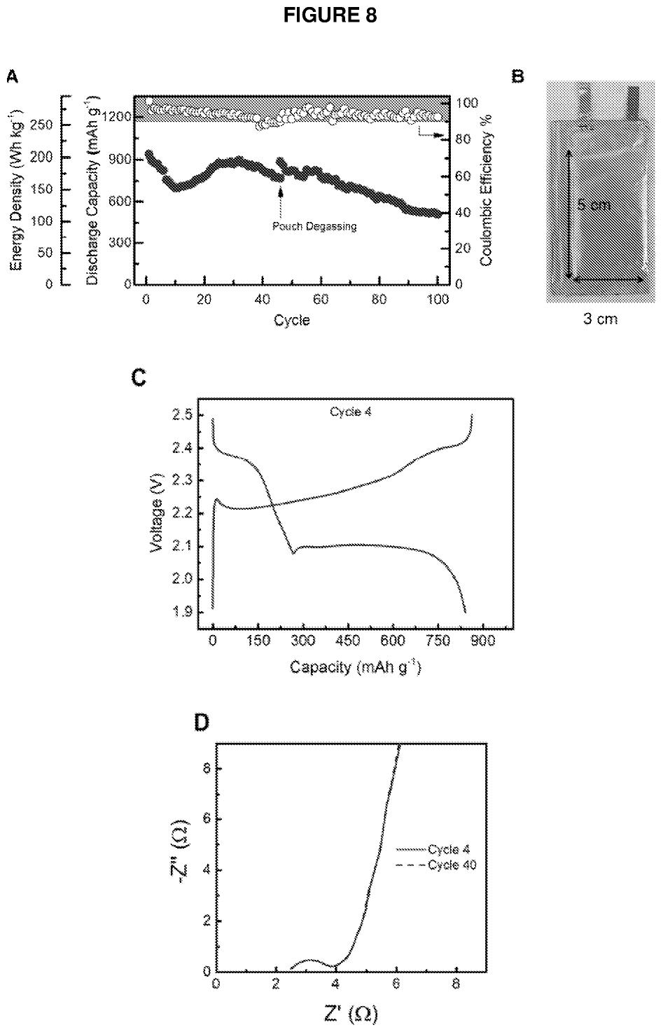

A pouch cell prototype was manufactured utilizing a EPL-rGO separator, double sided sulfur cathodes (at a single-side sulfur loading of 3 mg cm⁻², for 6 mg cm⁻² total) and 100 μm thick lithium metal anodes with an E/S ratio of 5. The delivered initial energy density was 202 Wh kg-1 and a capacity of 925 mAh g−1 at a rate of 0.05 C over 100 cycles. The cycling data is presented in FIG. 8A.

The charge-discharge profile in FIG. 8C shows that the onset of the second plateau is at 2.08V and at 290 mAh g⁻¹, indicating low polarization and low IR drop. The high voltages of the second plateau are essential for energy density. The Nyquist plots in FIG. 8D shows that the impedance spectrum demonstrates negligible changes even after 40 cycles.

### Example 11: Lithium Ion Transport Studies

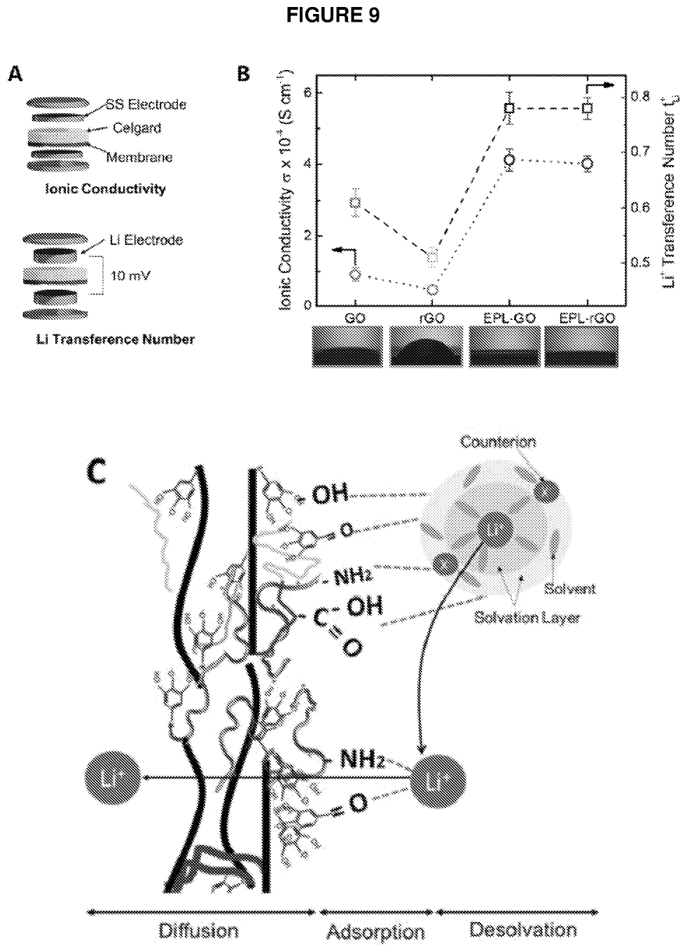

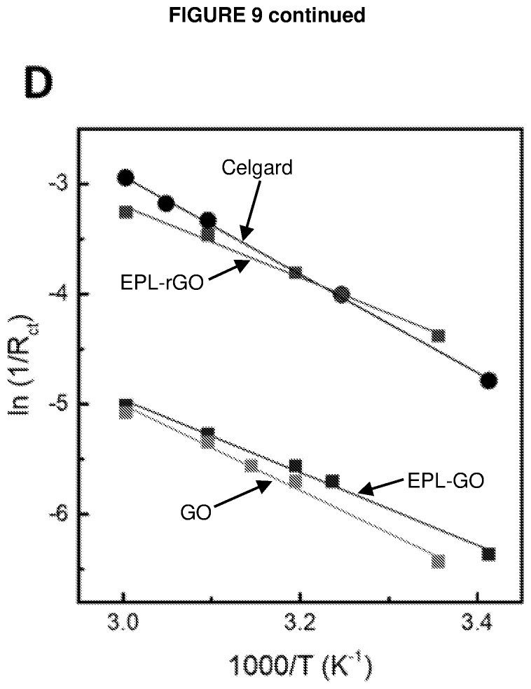

FIG. 9A shows the cell configurations for measuring ionic conductivity and Li⁺ transference number. FIG. 9B illustrates the results for different interlayers and images of the electrolyte contact angle for different interlayers are also shown.

Rapid Li⁺ ion transport is crucial to make Li⁺ ions more readily available at the cathode and enable the reactions with sulfur during discharge (and the opposite during charging) and in turn improve sulfur utilization, CE and cycle life. In electrochemical devices, ion transport of the separator is characterized in terms of the ionic conduction (σ^{m}), which is comprised of diffusive and electro-potential driving forces; and the Li+ transference number (t_{Li}_{⁺}), which describes the ionic current carried by Li⁺ out of the total current carried by both Li⁺ and its co-ions such as TFSI⁻ and NO₃⁻.

Since the solvated radius of Li⁺ is significantly larger than the pore size required to reject LiPS, i) the first step is that Li⁺ must undergo desolvation and splitting of the ion pair at the interlayer surface; ii) then the Li⁺ ion must ‘adsorb’ and ‘stabilize’ to partition into the pores; iii) followed by diffusion through the interlayer, which can be explained as a series of forming, breaking and re-forming of bonds with the next coordinate atom. The schematic in FIG. 9C outlines a proposed mechanism.

The activation energy required for Li⁺ transport through the interlayers was calculated from the slopes in FIG. 9D. The activation energy with 95% confidence for Celgard is 32.1±0.39 KJ mol⁻¹, while for GO it is 33.2±0.23 KJ mol⁻¹. Upon the addition of EPL, it improves to 27.3±0.50 KJ mol⁻¹ for EPL-GO and a similar value of 26.9±0.42 KJ mol⁻¹ for EPL-rGO.

### Example 12: Separator Electrocatalytic Activity

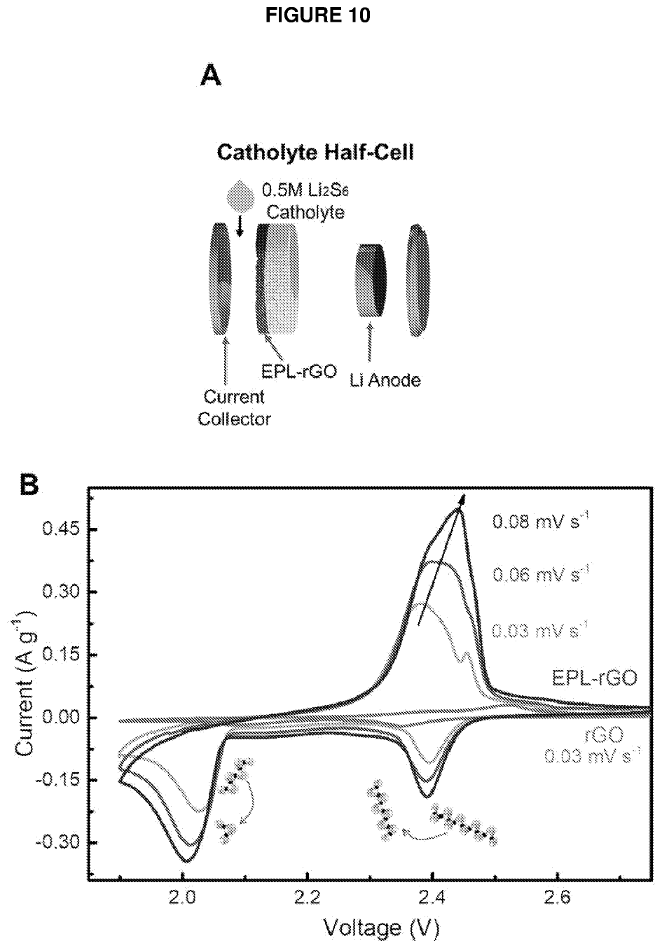

To confirm that EPL-rGO has redox-mediating properties, coin cells were assembled with different interlayers facing the bottom casing current collector with 0.5 M Li₂S₆ in electrolyte (catholyte) and a Li anode. The setup is shown in FIG. 10A. CV scans at three different scan rates in FIG. 10B reveal two cathodic peaks, consistent with the conversion of higher-order LiPS to short-chain LiPS and then to the final discharge product, Li₂S, while the anodic scan displays peaks for the reverse process. The strong, sharp peaks in the presence of only the EPL-rGO material (in the absence of sulfur or conductive carbon additives) strongly validates that it possesses excellent catalytic activity and kinetics for LiPS conversion.

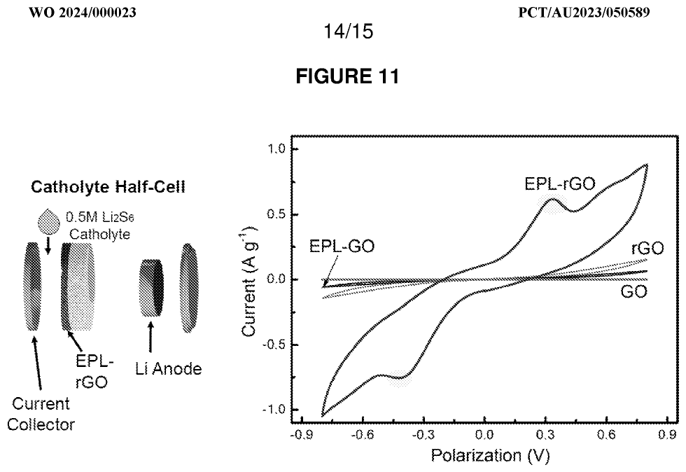

Complementary experiments to establish electrocatalytic activity towards LiPS were performed in symmetrical cell experiments. Symmetrical cells were assembled with identical working and counter electrodes in 0.5 M catholyte. Cells were cycled between-0.8 V and 0.8 V at a scan rate of 10 mV s⁻¹, which are displayed in FIG. 11. The highest current response was for EPL-rGO, consistent with the concept of redox-mediating interlayers playing a major role in enhancing LiPS redox kinetics and in line with the observation from the catholyte cells. The peaks at +0.35 V and −0.42 V are consistent with the reduction and oxidation of Li₂S₆ on the interlayer surface. These results are in stark contrast with the other interlayers. The GO and EPL-GO display negligible peaks due to a lack of electronic conductivity, while rGO displays broad anodic and cathodic peaks with ˜20 times lower current density due to a lack of interaction and low affinity with LiPS.

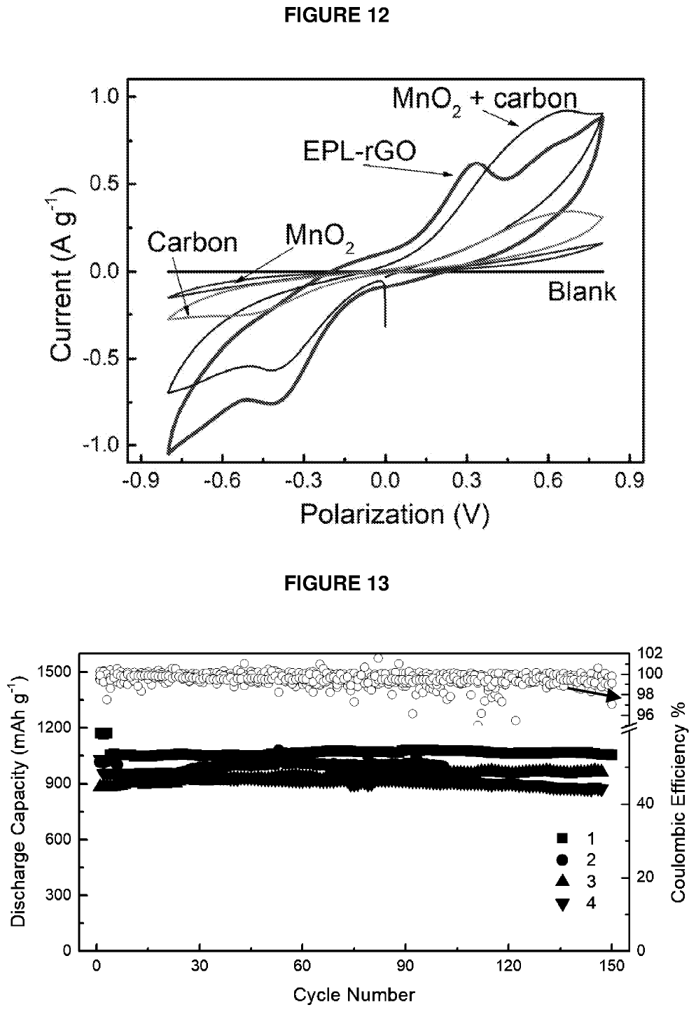

A comparison was also made with commonly studied redox mediator materials in Li—S batteries in FIG. 12, maintaining the same mass ratio of LiPS to redox-mediator material for a fair comparison. Without the addition of a conductive additive, the EPL-rGO interlayer outperformed well-known electrocatalytic materials giving sharper peaks and higher current density. It is only with the addition of a conductive carbon that the CV curves are comparable. The notable exception is that these coatings, unlike EPL-rGO, are not permselective, have lower LiPS adsorption capacity compared to EPL-rGO, and require considerably higher electrolyte volumes for complete wetting.

### Example 13: Preparation and Use of Further Elastic Polyelectrolyte Liquids (EPLs)

Further elastic polyelectrolyte liquids (EPLs) were prepared as described in Example 1 using various polyphenols, cationic polymers, and facilitated ion transport proteins, and with mass ratio of 60:15:25. The formulations are shown in Table 2.

TABLE 2

| Formulation # | Polyphenol | Protein | Cationic polymer |
|---|---|---|---|
| 1 | caffeic acid | BSA | PEI |
| 2 | tannic acid | lysosome | PEI |
| 3 | tannic acid | BSA | pDADMAC |
| 4 | gallic acid | BSA | PEI |

Interlayer materials were prepared as in Example 2 comprising the EPL formulations 1 to 4 of Table 2 and graphene oxide (GO) with EPL:GO ratios of 1:2. Reduction was performed for 12 h at 70° C., and the respective EPL-rGO formulations were coated onto Celgard substrate as in Example 5. Adhesion onto the substrate and membrane quality was observed to be of good quality.

Coin cells were prepared as in Example 9 at a sulfur loading of 3 mg cm⁻² and the cycling performance of the different separators at a cycling rate of 0.25 C were compared.

FIG. 13 illustrates that the four formulations (1, 2, 3, and 4) showed minimal capacity decay over 150 cycles.

### Electrochemical Characterizations

The ionic conductivity of the separators was calculated from EIS, and was repeated three times. Each separator was saturated with electrolyte (20 μL) and sandwiched between two stainless steel electrodes in coin cells. It was rested for 12 h, and the ionic conductivity was calculated according to the following equation:

$$σ = \frac{L}{{R}_{b} A}$$

where σ is the ionic conductivity, L is the thickness of the interlayer, A was the area of the stainless steel electrodes and Rb is the bulk resistance. The Li⁺ transference number was calculated by the Bruce-Vincent method, by AC impedance measurements in combination with DC polarization. The electrolyte soaked separator (20 μL) was placed between two Li electrodes in a coin cell. The Li⁺ transference number

$${t}_{Li}^{+}$$

was then calculated according to the equation:

$${t}_{Li}^{+} = \frac{{I}_{SS} ( Δ V - {I}_{0} {R}_{SS} )}{{I}_{0} ( Δ V - {I}_{SS} {R}_{SS} )}$$

where the ΔV is the potential difference applied by the chronoamperometric step which was 10 mV, while I_{SS} and I₀ are the steady state and initial currents, while R_{SS} and R₀ is the steady state and initial interfacial resistances as determined by impedance spectroscopy. The activation energy was calculated based on the Arrhenius relation of the symmetrical cells. Holding all else constant, the activation energy Eₐ allowed for a comparison to be made based on the desolvation energy of Li⁺ and diffusion through the separator. The Arrhenius relation is given by:

$$\frac{1}{{R}_{ct}} = {Ae}^{{-}^{{E}_{a} / RT}}$$

where A is a pre-exponential factor, R_{ct} is the impedance (ohm), T is the temperature (K) and R is the gas constant (J mol⁻¹ K⁻¹).

### Separator Characterizations

The static electrolyte contact angle measurements were performed on separators using a sessile drop method using a Dataphysics OCA35 contact angle instrument, at room temperature and controlled humidity of 50% and the droplet amount was 6 μL. The electrolyte uptake of the separators was determined by soaking the electrolyte solutions for 2 hrs, and the weight of the separators was taken after removing excess electrolyte from the surface using filter paper. The test was carried out in an inert argon atmosphere in a glovebox. The electrolyte uptake was calculated using the equation:

$$EU \% = \frac{{W}_{wet} - {W}_{dry}}{{W}_{dry}} \times 100 \%$$

Solvent permeance, to test hydrodynamic permeability of different separators, was carried out in a dead-end filtration cell from Sterlitech (HP4750 Stirred Cell, Sterlitech USA) with an effective surface area of 14.6 cm². The pressure was maintained at 200 mbar and the mass and pressure recordings were taken every second using Radwag precision balances (PS1000.R2, Poland) and a Fluigent pressure pump (MFCS-EX, France). The separators were stabilized for 2 hrs to obtain the permeance result, and repeated three times to ensure reproducibilty. The permeance J is defined as:

$$J = \frac{{V}_{p}}{A P t}$$

where Vₚ is the volume permeated at time t, through an effective area A and an applied pressure P.

### Further Characterization Techniques

Fourier Transform Infrared Spectroscopy (FTIR) spectra were recorded using an attenuated total reflectance FTIR spectrometer (PerkinElmer, USA) in the range of 400-4000 cm⁻¹ at an average of 32 scans with a resolution of 2 cm⁻¹. X-ray photoelectron spectroscopy (XPS) was conducted to investigate the reduction of EPL-rGO by comparing the sp2 and sp3 peaks of the C 1s spectra before and after reduction. It was performed using a Nexsa Surface Analysis System (ThermoFisher Scientific, USA) with a monochromatic Al Kα source. Scanning Electron Microscopy (SEM, FEI Nova NanoSEM 450 FEG) was used to investigate morphology of nanoparticle images. The samples were mounted on an Al-stub and coated with iridium using a Cressington 208HRD sputter coated with a thickness of approximately 2 nm. Secondary electron images were collected at an acceleration voltage of 5 kV and a working distance of 5 mm. UV-Vis was used to determine lithium polysulfide concentration by firstly preparing a set of standards to make a calibration curve (Lambda 365, PerkinElmer, USA). X-ray diffraction (XRD) analysis using a Bruker D2 Phaser diffractometer with Cu Kα radiation generated at 30 KV and 10 mA at a scan rate of 0.4° min⁻¹ and a step size of 0.02°. Raman spectra were obtained using a Renishaw Confocal micro-Raman Spectrometer equipped with a HeNe (632.8 nm) laser operating at 10% power. Extended scans (10 s) were performed between 100 and 3200 wavenumbers with a laser spot size of 1 μm. Once the background was removed, the intensity of the spectra was normalized by dividing the data by the maximum intensity. A dynamic light scattering analyzer (NanoBrook 90Plus PALS, Brookhaven, USA) was used to evaluate the surface charge. Rheological tests were conducted using a strain-controlled AREAS G2 rheometer (TA instruments, USA) with a cone-plate geometry (cone angle 2° and cone diameter 50 mm). A constant gap of 0.045 mm was maintained during the tests. The temperature was controlled at 23.00±0.01° C. for the experiments. For steady-state measurements, shear rate range from 0.01 s⁻¹-100 s⁻¹ was used. Polarized light microscopy was carried using inverted Leica DM IRB Microscope fitted with Abrio polarizing imaging system from CRI Inc., and images were taken at birefringence set-up mode comprising a linear polarizer, an analyzer and two variable electro-optical retarded plates instead of the compensator. The polarized light transmitted through the specimen, loaded in a clean microscopic slide, passed through the analyzer and was captured by a CCD camera. The captured signals were successively processed using a digital image processing system to generate optical retardance and slow axis orientation images.

1. A permselective interlayer for a lithium-sulfur battery comprising:
a) one or more elastic polyelectrolyte liquids; and
b) one or more two dimensional conducting materials.

2. The permselective interlayer according to claim 1, wherein the interlayer comprises:
a) about 15 wt. % to about 45 wt. % of one or more elastic polyelectrolyte liquids; and
b) about 40 wt. % to about 80 wt. % of one or more two dimensional conducting materials;
based on the total weight of the permselective interlayer.

3. The permselective interlayer according to claim 2, wherein the interlayer comprises:
a) about 20 wt. % to about 40 wt. % of one or more elastic polyelectrolyte liquids; and
b) about 40 wt. % to about 80 wt. % of one or more two dimensional conducting materials;
based on the total weight of the permselective interlayer.

4. The permselective interlayer according to any one of claims 1 to 3, wherein the weight ratio of the one or more elastic polyelectrolyte liquids to the one or more two dimensional conducting materials is from about 1:1.5 to about 1:3.5.

5. The permselective interlayer according to any one of claims 1 to 4, wherein the elastic polyelectrolyte liquid comprises a mixture of:
a) about 50 wt. % to about 80 wt. % of one or more polyphenols;
b) about 5 wt. % to about 40 wt. % of one or more cationic polymers; and
c) about 5 wt. % to about 35 wt. % of one or more facilitated ion transport proteins;
based on the total weight of the elastic polyelectrolyte liquid.

6. The permselective interlayer according to any one of claims 1 to 5, wherein the elastic polyelectrolyte liquid comprises a mixture of:
a) about 50 wt. % to about 80 wt. % of one or more polyphenols;
b) about 15 wt. % to about 40 wt. % of one or more cationic polymers; and
c) about 5 wt. % to about 35 wt. % of one or more facilitated ion transport proteins;
based on the total weight of the elastic polyelectrolyte liquid.

7. The permselective interlayer according to any one of claims 1 to 6, wherein the elastic polyelectrolyte liquid comprises a mixture of:
a) about 50 wt. % to about 70 wt. % of one or more polyphenols;
b) about 15 wt. % to about 35 wt. % of one or more cationic polymers; and
c) about 10 wt. % to about 30 wt. % of one or more facilitated ion transport proteins;
based on the total weight of the elastic polyelectrolyte liquid.

8. The permselective interlayer according to claim 6 or claim 7, wherein the one or more polyphenols have a molecular weight from about 100 to about 20,000 Daltons.

9. The permselective interlayer according to any one of claims 6 to 8, wherein the one or more polyphenols comprise one or more of tannic acid, caffeic acid, gallic acid, ellagitannin, gallotannin, elagic acid, proanthocyanidins, and curcumin.

10. The permselective interlayer according to any one of claims 6 to 9, wherein the one or more cationic polymers comprise amine functions.

11. The permselective interlayer according to any one of claims 6 to 9, wherein the one or more cationic polymers comprise one or more of polyethylenimine, poly(allylamine) hydrochloride, poly(lysine), poly(DADMAC) and chitosan.

12. The permselective interlayer according to any one of claims 6 to 11, wherein the one or more facilitated ion transport proteins comprise one or more of bovine serum albumin, lysosome, ovalbumin and valinomycin.

13. The permselective interlayer according to any one of claims 1 to 12, wherein the one or more two dimensional conducting materials comprise one or more of reduced graphene oxide, transition metal dichalcogenides, metal-organic frameworks, phosphorenes, and nitrides.

14. The permselective interlayer according to claim 13, wherein the transition metal dichalcogenide comprises one or more of MX₂, wherein Mis Mo, W or V and X is S, Se or Te.

15. The permselective interlayer according to any one of claims 1 to 14, wherein the interlayer comprises both hydrophilic and hydrophobic domains.

16. The permselective interlayer according to any one of claims 1 to 15, wherein the interlayer has a zero shear viscosity of less than 500 Pa·s measured between 20° C. and 25° C.

17. A separator for a lithium-sulfur battery, comprising a porous substrate coated with the permselective interlayer according to any one of claims 1 to 16.

18. The separator according to claim 17, wherein the permselective interlayer coating comprises pores of a size sufficiently large to permit the transport of lithium ions through the separator.

19. The separator according to claim 17 or claim 18, wherein the permselective interlayer coating comprises pores of a size sufficiently small to hinder the transport of polysulfide species through the separator.

20. The separator according to any one of claims 17 to 19, wherein the permselective interlayer coating mitigates the accumulation of polysulfide species on the surface of the permselective interlayer coating.

21. The separator according to any one of claims 17 to 20, wherein the porous substrate comprises one or more polyolefins.

22. The separator according to any one of claims 17 to 21, wherein the permselective interlayer coating thickness is from about 100 nm to about 400 nm, or from about 150 nm to about 350 nm, or from about 200 nm to about 300 nm.

23. A lithium sulfur battery comprising a lithium anode, a sulfur cathode, a separator coated with the permselective interlayer according to any one of claims 1 to 16, and electrolyte disposed between the anode and cathode.

24. The lithium sulfur battery according to claim 23, wherein, during charging or discharging, the permselective interlayer coating mitigates the accumulation of polysulfide species on the surface of the permselective interlayer coating.

25. The lithium sulfur battery according to claim 24, wherein, during charging and discharging, the permselective interlayer coating oxidises and reduces polysulfide species.

26. The lithium sulfur battery according to any one of claims 23 to 25, wherein, during charging or discharging, the permselective interlayer coating facilitates the transport of lithium ions through the separator.

27. The lithium sulfur battery according to any one of claims 23 to 26, wherein, during charging or discharging, the permselective interlayer coating hinders the transport of polysulfide species through the separator.

28. The lithium sulfur battery according to claim 27, wherein the permselective interlayer coating hinders the transport of more than 90% of polysulfide species through the separator, or more than 95%, or up to 99%, or greater.

29. The lithium sulfur battery according to any one of claims 23 to 28, wherein an electrolyte volume to capacity ratio is less than or equal to 5 μL mAh⁻¹.

30. A method of producing a permselective interlayer according to any one of claims 1 to 16 comprising combining one or more elastic polyelectrolyte liquids with one or more two dimensional conducting materials.

31. The method according to claim 30, wherein the two dimensional conducting material is graphene oxide.

32. The method according to claim 31, wherein the combination of one or more elastic polyelectrolyte liquids and graphene oxide are heated to a temperature greater than 60° C., so as reduce at least some of the graphene oxide.

33. The method according to any one of claims 30 to 32, wherein the weight ratio of the one or more elastic polyelectrolyte liquids to the one or more two dimensional conducting materials is from about 1:1.5 to about 1:3.5.

34. A method of producing a separator according to any one of claims 17 to 22, comprising coating a porous substrate with a permselective interlayer according to any one of claims 1 to 16.

35. An elastic polyelectrolyte liquid comprising a mixture of one or more polyphenols, one or more cationic polymers and one or more facilitated ion transport proteins.

36. A method of preparing an elastic polyelectrolyte liquid according to claim 35 comprising:
a) combining one or more polyphenols and one or more cationic polymers; and
b) adding one or more facilitated ion transport proteins,
wherein a) and b) are performed under acidic conditions.
